(19) United States
(12) Patent Application Publication
(10) Pub. No.: US 2007/0272065 A1
(43) Pub. Date: Nov. 29, 2007

(54) Slicing Device with a Curvable Loading Pinion

(76) Inventor: Ralf P. Muller, Kempten (DE)

Correspondence Address: FOLEY & LARDNER LLP, 777 EAST WISCONSIN AVENUE, MILWAUKEE, WI, 53202-5306, US

(21) Appl. No.: 10/578,587

(22) PCT Filed: Nov. 12, 2004
(86) PCT No.: PCT/EP04/12864

§ 371 Date: May 7, 2007

(30) Foreign Application Priority Data
Nov. 14, 2003 (DE) 103 53 527.6

(51) Int. Cl. A22C 17/02

(52) U.S. Cl. 83/155; 83/109; 83/156

(57) ABSTRACT

The invention relates to a device for slicing blocks of foodstuffs, comprising a blade (2) wherein the block of foodstuff can be reversibly lifted from a first position into a second position by means of a loading pinion (3) and the loading pinion (3) is curved at least in one position thereof. The invention also relates to a method for slicing at least one block of foodstuff.

The present invention relates to a device for slicing food products in block form with a blade, in which the food product block may be raised reversibly with a rocking loading arm from a first into a second position and the rocking loading arm is curved at least in one position. The present invention further relates to a method of slicing at least one food product block.

Bar-shaped food products, for example sausage, cheese and the like are currently cut into slices using high-performance slicing machines, so-called slicers. The food product bar is conveyed by means of a controlled drive through a stationary cutting plane, in which cutting is performed by a rapidly moving blade. In order to be able to exploit downslope forces for conveying said food product block, it is often brought into a position inclined relative to horizontal. This inclination is achieved as a rule by a “rocking loading arm”, for example a straight conveyor belt or a roller conveyor, which may be pivoted between a substantially horizontal loading position, in which the food product block is loaded onto the rocking loading arm, and a slicing position, in which the rocking loading arm is inclined in the direction of the blade. However, this slicing machine or rocking loading arm has the disadvantage that very high downslope forces may occur with food product blocks which may be up to two metres long, or so-called catapult effects may arise if the outer end of the food product block is raised quickly, which can only be avoided by slowing the upwards movement of the rocking loading arm, which in turn increases loading times.

Furthermore, such slicing machines can only be used in locations with a comparatively large amount of overhead clearance.

It was therefore an object of the present invention to provide a slicing machine which does not exhibit the disadvantages of the prior art.

This object is achieved according to the invention by a device for slicing food products in block form according to claim 1. Preferred embodiments of the device according to the invention are claimed in claims 2 to 8.

It was extremely surprising to the person skilled in the art and not at all expected that it should be possible with the device according to the invention to cut even very long food product blocks without the downslope forces becoming uncontrollably great. Moreover, the catapult effects, which occur when raising the food product block from the loading to the cutting position, are reduced significantly, such that the speed at which the rocking loading arm is raised from one position into the other position may be increased, so in turn reducing loading times. The device according to the invention is simple and economic to produce and operate. The device according to the invention for slicing food products may be used in a location with comparatively little overhead clearance.

According to the invention, the rocking loading arm is raised from a first into a second position and preferably pivoted in the process about a pivot, wherein the rocking loading arm is curved in at least one position. Curvature for the purposes of the invention is preferably curvature perpendicular to the conveying direction of the food product block. Preferably, the rocking loading arm is oriented substantially horizontally in the first, so-called loading position, while it is inclined substantially relative to the horizontal and curved in the second, raised slicing position, wherein the part of the rocking loading arm closest to the blade is preferably parallel to the axis of rotation of the blade and the part most remote therefrom preferably exhibits the least inclination relative to horizontal. Preferably, curvature of the rocking loading arm is achieved by at least one joint, preferably a hinge, whose swivel axis extends perpendicularly to the direction in which the food product block is conveyed.

Preferably, the device according to the invention may be used to slice a plurality of food product blocks in. parallel, these preferably being arranged next to one another on the rocking loading arm. The rocking loading arm therefore preferably comprises so-called guide rolls, i.e. rolls which have indentations at their outer periphery, in which the food product blocks are guided. Moreover, in addition or as an alternative to the guide rolls, the rocking loading arm preferably comprises guide elements, for example strips, which are arranged parallel to the food product blocks and define the particular product track.

In a further preferred embodiment, the rocking loading arm comprises a limit stop 8 at its end closest to the blade, against which limit stop the food product rests before pivoting and before slicing. This limit stop is removed as soon as the food product blocks are held in the inclined position by other means, for example conveyor belts and/or a gripper. The device according to the invention makes it possible to slice even very long food product blocks in locations with comparatively little overhead clearance.

The present invention further provides a method of slicing at least one food product block, wherein the food product block is transferred from a loading into a slicing position prior to slicing using a rocking loading arm and the shape of the rocking loading arm is modified on transfer from one position to the other.

Preferably, the rocking loading arm is curved perpendicularly to the conveying direction of the food product blocks.

It is also preferable for the food product block, which lies on the rocking loading arm, to be bent perpendicularly to its conveying direction on transfer of the rocking loading arm.

It was extremely surprising to the person skilled in the art and not at all expected that it should be possible, with the method according to the invention, to slice food product blocks of any length.

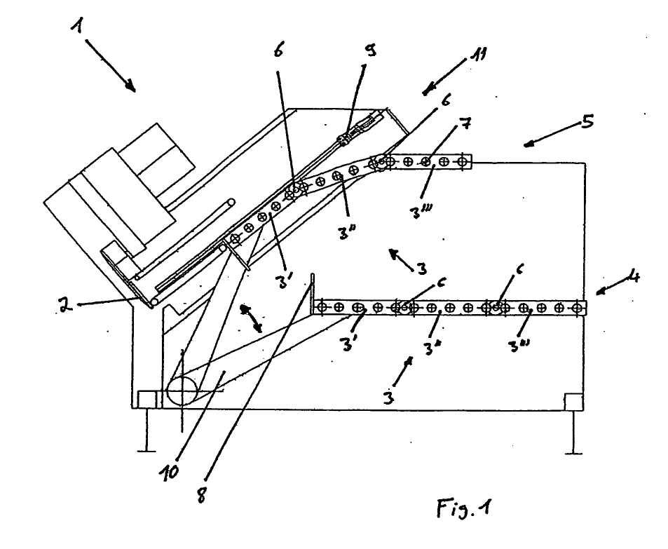

The invention is [explained] below with reference to FIG. 1. The explanations are given merely by way of example and do not restrict the general concept of the invention.

FIG. 1 shows the device according to the invention for slicing food products in block form. The device according to the invention makes it possible to slice a plurality of food product blocks in parallel with one another. The slicer according to the invention comprises a blade 2 which is inclined relative to horizontal. The food product blocks are preferably positioned one behind the other in the plane of the paper on the rocking loading arm 3, which is initially in the so-called loading position 4, and pushed against the limit stop 8. The rocking loading arm comprises rollers 7, such that the food product blocks may easily be conveyed parallel to the plane of the paper. The person skilled in the art will recognise that the rocking loading arm may also comprise conveyor belts instead of or in addition to the rollers. In the present case, the rocking loading arm 3 consists of three sub-zones 3′, 3″, 3′″, which are connected together by two joints 6. In the loading position the rocking loading arm 3 preferably rests on a limit stop, such that its overall orientation is horizontal in this position. Once the rocking loading arm 3 has been loaded with at least one food product block, it is transferred by the pivoting mechanism 10 from the horizontal position into an inclined slicing position 5. The movement of the pivoting mechanism 10 is illustrated by the double-headed arrow. The three elements 3′″, 3″ and 3′ of the rocking loading arm 3, which were oriented horizontally in the loading position, now each exhibit a different position relative to one another, such that the rocking loading arm is curved overall perpendicularly to the conveying direction 11 of the food product block. A food product block (not shown) lying on the rocking loading arm is forced against the rocking loading arm by gravity and is thereby likewise curved. Due to the curvature of the rocking loading arm, the structural height of the device according to the invention is comparatively low. Furthermore, catapult effects, which the food product block experiences while it is being raised from the loading position 4 into the slicing position 5, are less significant than in the case of a straight rocking loading arm according to the prior art. Furthermore, FIG. 1 shows a gripper 9, which is brought into contact with the end of the food product block (not shown) remote from the blade. Since the food product block initially extends optionally as far as the outermost end of the portion 3′″ of the rocking loading arm 3, the person skilled in the art will recognise that the gripper 9 may be brought into contact with the food product block and anchored therein only when the end of the food product block remote from the blade is in front of the gripper 9 relative to the conveying direction 11 of the food product block. However, the gripper 9 is preferably brought into engagement with the rear end of the food product block only when it is located at least on the part of the rocking loading arm 3 designated 3′. To this end, the gripper 9 is moved in the direction marked with the arrow 11 until it reaches the rear end of the food product block. After slicing of the food product block(s), the rocking loading arm is transferred back into the loading position 4 and loaded with at least one food product block.

### LIST OF REFERENCE NUMERALS

1 Device for slicing food products

2 Blade

3 Rocking loading arm

4 First position, loading position

5 Second position, slicing position

6 Hinge

7 Guide rolls

8 Limit stop

9 Gripper

10 Pivoting mechanism

11 Conveying direction of the food product block during slicing

1-13. (canceled)

14. A device for slicing food products in block form with a blade, comprising:
a rocking loading arm;
wherein the rocking loading arm is configured such that a food product block may be reversibly raised with the rocking loading arm from a first position to a second position;
wherein the rocking loading arm is curved at least when in a slicing position; and
wherein the rocking loading arm is oriented substantially horizontally when in a loading position.

15. The device of claim 14, wherein the first position is the loading position and the second position is the slicing position.

16. The device of claim 14, wherein the rocking loading arm is inclined substantially relative to horizontal in the slicing position.

17. The device of claim 14, wherein the rocking loading arm comprises at least one joint.

18. The device of claim 14, wherein the rocking loading arm comprises at least one guide roll.

19. The device of claim 14, wherein the rocking loading arm comprises at least one flexible conveyor belt.

20. The device of claim 14, wherein the rocking loading arm comprises a limit stop at one end for the food product block.

21. The device of claim 14, wherein the rocking loading arm is configured such that a plurality of food blocks may be sliced in parallel.

22. The device of claim 21, further comprising a plurality of product tracks arranged in parallel, wherein each of the plurality of product tracks is configured to guide one of the plurality of food blocks.

23. The device of claim 22, further comprising lateral guide elements arranged between the product tracks.

24. A method of slicing at least one food product block, comprising:
transferring a food product block from a loading position to a slicing position prior to slicing using a rocking loading arm;
wherein the shape of the rocking loading arm is modified on transfer from the loading position to the slicing position; and
wherein the food product block is bent on transfer of the rocking loading arm.

25. The method of claim 24, wherein the rocking arm is curved perpendicularly to a conveying direction of the food product block.
